(19) United States
(12) Patent Application Publication
(10) Pub. No.: US 2024/0045929 A1
(43) Pub. Date: Feb. 8, 2024

(54) SYSTEMS AND METHODS FOR AUTO-THRESHOLDING USING PAIRWISE FEATURE CROSS-CORRELATION FOR HYPERPARAMETER VALUE SELECTION

(71) Applicant: JPMORGAN CHASE BANK, N.A., New York, NY (US)

(72) Inventors: Rohan SAPHAL, New York, NY (US); Fanny SILAVONG, New York, NY (US); Sean MORAN, London, NY (US)

(21) Appl. No.: 17/817,769

(22) Filed: Aug. 5, 2022

(51) Int. Cl. G06K 9/62

(52) U.S. Cl. CPC G06K 9/6218; G06K 9/6228; G06K 9/6232

(57) ABSTRACT

Systems and methods for auto-thresholding using pairwise feature cross-correlation for hyperparameter value selection are disclosed. A method may include a hyperparameter value optimization computer program: receiving data to be used by a clustering algorithm; receiving a selection of a hyperparameter value to tune; for each possible hyperparameter value, executing the clustering algorithm resulting in a set of clusters for each hyperparameter value; extracting a series of cluster features from the set of clusters; performing pairwise cross-correlation on the series of cluster features resulting in potential candidates for an optimal hyperparameter value; aggregating maximum or minimum values for the hyperparameter value at their respective indices; selecting an optimum value for the hyperparameter value; and outputting the optimum value for the hyperparameter value to the clustering algorithm.

### BACKGROUND OF THE INVENTION

### 1. Field of the Invention

Embodiments relate generally to systems and methods for auto-thresholding using pairwise feature cross-correlation for hyperparameter value selection.

### 2. Description of the Related Art

Large scale deployment of machine learning clustering algorithms can be an extremely challenging task. Typically, these are off-the shelf algorithms or customized algorithms aimed at trying to solve a specific problem. Since there are usually no labels for the task at hand, the algorithm is tuned for different values of a hyperparameter, followed by a manual analysis. The manual analysis is often focused at identifying the optimal parameter, a process that is called “thresholding.” Automating the identification of the optimal parameter is known as “auto-thresholding.”

### SUMMARY OF THE INVENTION

Systems and methods for auto-thresholding using pairwise feature cross-correlation for hyperparameter value selection are disclosed. According to one embodiment, a method for auto-thresholding using pairwise feature cross-correlation for hyperparameter value selection may include: (1) receiving, by a hyperparameter value optimization computer program executed by an electronic device, data to be used by a clustering algorithm; (2) receiving, by the hyperparameter value optimization computer program, a selection of a hyperparameter value to tune; (3) for each possible hyperparameter value, executing, by the hyperparameter value optimization computer program, the clustering algorithm resulting in a set of clusters for each hyperparameter value; (4) extracting, by the hyperparameter value optimization computer program, a series of cluster features from the set of clusters; (5) performing, by the hyperparameter value optimization computer program, pairwise cross-correlation on the series of cluster features resulting in potential candidates for an optimal hyperparameter value; (6) aggregating, by the hyperparameter value optimization computer program, maximum or minimum values for the hyperparameter value at their respective indices; (7) selecting, by the hyperparameter value optimization computer program, an optimum value for the hyperparameter value; and (8) outputting, by the hyperparameter value optimization computer program, the optimum value for the hyperparameter value to the clustering algorithm.

In one embodiment, the clustering algorithm may include K-means clustering, DBScan, etc.

In one embodiment, the cluster features may include a first order difference in size, a normalized entropy, a Davies-Bouldin score, a Calinski-Harabasz index, and a silhouette coefficient.

According to another embodiment, a non-transitory computer readable storage medium, may include instructions stored thereon, which when read and executed by one or more computer processors, cause the one or more computer processors to perform steps comprising: receiving a selection of a hyperparameter value to tune for a clustering algorithm; for each possible hyperparameter value, executing the clustering algorithm resulting in a set of clusters for each hyperparameter value; extracting a series of cluster features from the set of clusters; performing pairwise cross-correlation on the series of cluster features resulting in potential candidates for an optimal hyperparameter value; aggregating maximum or minimum values for the hyperparameter value at their respective indices; selecting an optimum value for the hyperparameter value; and outputting the optimum value for the hyperparameter value to the clustering algorithm.

In one embodiment, the clustering algorithm and may include K-means clustering, DBScan, etc.

In one embodiment, the cluster features may include a first order difference in size, a normalized entropy, a Davies-Bouldin score, a Calinski-Harabasz index, and a silhouette coefficient.

An electronic device may include a computer processor; and a memory storing a hyperparameter value optimization computer program. When executed by the computer processor, the hyperparameter value optimization computer program: receives a selection of a hyperparameter value to tune for a clustering algorithm; for each possible hyperparameter value, executes the clustering algorithm resulting in a set of clusters for each hyperparameter value; extracting a series of cluster features from the set of clusters; performs pairwise cross-correlation on the series of cluster features resulting in potential candidates for an optimal hyperparameter value; aggregates maximum or minimum values for the hyperparameter value at their respective indices; selects an optimum value for the hyperparameter value; and outputs the optimum value for the hyperparameter value to the clustering algorithm.

In one embodiment, the clustering algorithm and may include K-means clustering, DBScan, etc.

In one embodiment, the cluster features may include a first order difference in size, a normalized entropy, a Davies-Bouldin score, a Calinski-Harabasz index, and a silhouette coefficient.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for auto-thresholding using pairwise feature cross-correlation for hyperparameter value selection according to an embodiment;

FIG. 2 depicts a method for auto-thresholding using pairwise feature cross-correlation for hyperparameter value selection according to an embodiment; and

FIG. 3 depicts an exemplary computing system for implementing aspects of the present disclosure.

### DETAILED DESCRIPTION OF PREFERRED EMBODIMENTS

Embodiments relate generally to systems and methods for auto-thresholding using pairwise feature cross-correlation for hyperparameter value selection.

Embodiments may use cross-correlation between different properties and metrics of clusters during the clustering phase to identify the optimal parameter. Thus, as the hyperparameter value changes, the properties and metrics also change, resulting in a pattern of variation. Embodiments may assume that, for the optimal hyperparameter value, all the different properties and metrics are highly correlated to each other, resulting in its identification.

Embodiments may identify the optimal hyperparameter value, K, in an end-to-end fashion with minimal, or no, human supervision.

In embodiments, a clustering algorithm may be executed for different candidate values for the hyperparameter value and the respective output clusters are obtained. The clusters may be used to extract certain features that may be used for pairwise cross-correlation. Indices of the maximum values from cross-correlation may be used to curate a set of candidate values for the hyperparameter value, and aggregation schemes such as mean, median, etc. may be used to obtain the optimal value for the hyperparameter value from the candidate set.

Embodiments may provide the following: (1) flexibility, in terms of its capability to tackle scenarios with minimum external/human input: (2) accuracy, in terms of being able to the optimal hyperparameter value; (3) scalability, in terms of automating an entire pipeline to run on its own without any human input; and (4) usefulness, as unlike existing solutions auto-thresholding requires little to no specification of the problem information.

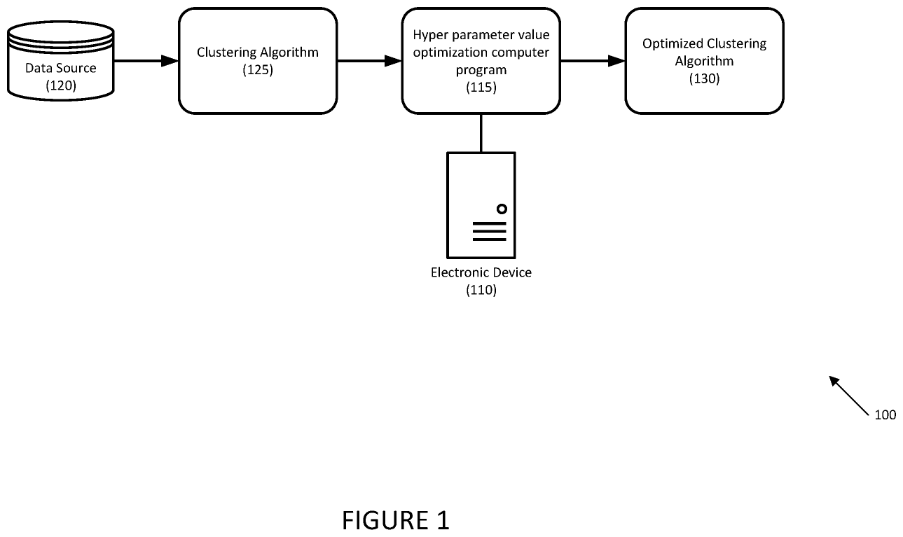

Referring to FIG. 1, a system for auto-thresholding using pairwise feature cross-correlation for hyperparameter value selection is disclosed according to an embodiment. System 100 may include electronic device 110 which may be any suitable electronic device, including servers (cloud and/or physical), computers (e.g., workstations, desktops, laptops, notebooks, tablets, etc.). Electronic device 110 may execute hyperparameter value optimization computer program 115.

Hyperparameter value optimization computer program 115 may receive model output from one or more clustering algorithm 125, which may cluster data from data source 120 and may determine an optimal value for a hyperparameter value for the data. Thus, hyperparameter value optimization computer program 115 is agnostic to machine learning tasks and the data source.

Once the optimal value for the hyperparameter value is identified, the optimal value for the hyperparameter value may be used with the same algorithm that is being optimized, resulting in optimized clustering algorithm 130. An example use case may include (a) applying K-Mean Clustering for document duplication detection, (b) running K-Mean for n different values of clusters, (c) obtaining metrics and properties for each of the n cluster setup, (d) applying auto-thresholding to metrics and properties, (e) obtaining an optimal cluster value, and (f) using the optimal value to run K-Mean Clustering in real-life/production. In embodiments, the auto thresholding algorithm is agnostic to the clustering algorithm (e.g., K-means clustering, DBScan, etc.).

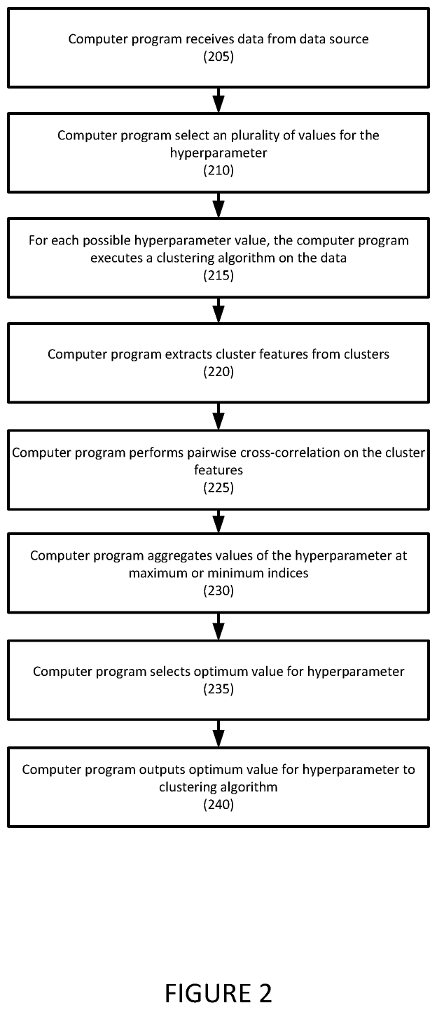

Referring to FIG. 2, a method for auto-thresholding using pairwise feature cross-correlation for hyperparameter value selection is disclosed according to an embodiment.

In step 205, a hyperparameter value optimization computer program executed by an electronic device may receive, data to be used by a clustering algorithm from a data source.

In step 210, the hyperparameter value optimization computer program may receive a selection of a hyperparameter value to tune. In one embodiment, a user may identify the hyperparameter values for the hyperparameter value optimization computer program.

In step 215, for each possible hyperparameter value, the hyperparameter value optimization computer program may execute the clustering algorithm. Examples may include K-means clustering, DBScan, etc. The output is a set of clusters for each possible hyperparameter value.

In step 220, the hyperparameter value optimization computer program may extract cluster features from the clusters. Examples of cluster features include the first order difference in size (e.g., the first order difference in the size of the largest cluster for different values of epsilon), normalized entropy (e.g., the normalized entropy calculated over the largest cluster for different values of epsilon), the Davies-Bouldin score (e.g., indicates the level of similarity between clusters, with a lower score indicating better separation between the clusters, the Calinski-Harabasz index (e.g., the ratio of inter-cluster separation to intra cluster separation that indicates the density and separation of the clusters, where a higher value indicates better clusters), and a silhouette coefficient (e.g., defined for each sample and is calculated based of 2 components).

In one embodiment, a single value may be provided for each cluster feature. For example, if N different hyperparameter values are tried, N values will be returned.

Other cluster features may be used as is necessary and/or desired.

In step 225, the hyperparameter value optimization computer program may perform pairwise cross-correlation on the series of cluster features. For example, for each pair of cluster features, the hyperparameter value optimization computer program may determine a correlation between the cluster features. In one embodiment, the output of the pairwise cross-correlation may be a series of cross-correlation values, where the X minimum or maximum values are potential candidates of the optimal hyperparameter values.

In step 230, the hyperparameter value optimization computer program may aggregate the values for the hyperparameter value at maximum or minimum indices. For example, the hyperparameter value optimization computer program may identify the value of the hyperparameter value at the maximum or minimum value, and may then aggregate the maximum or minimum values using the mean, the median, etc. for the hyperparameter values identified as potential candidates.

In step 235, the hyperparameter value optimization computer program may select an optimum value for the hyperparameter value. The optimal value for the clustering algorithm is the one that gives the best result on the labelled dataset.

In step 240, the hyperparameter value optimization computer program may then provide the optimal value for the hyperparameter value to the clustering algorithm and the optimal value may be used by the clustering algorithm.

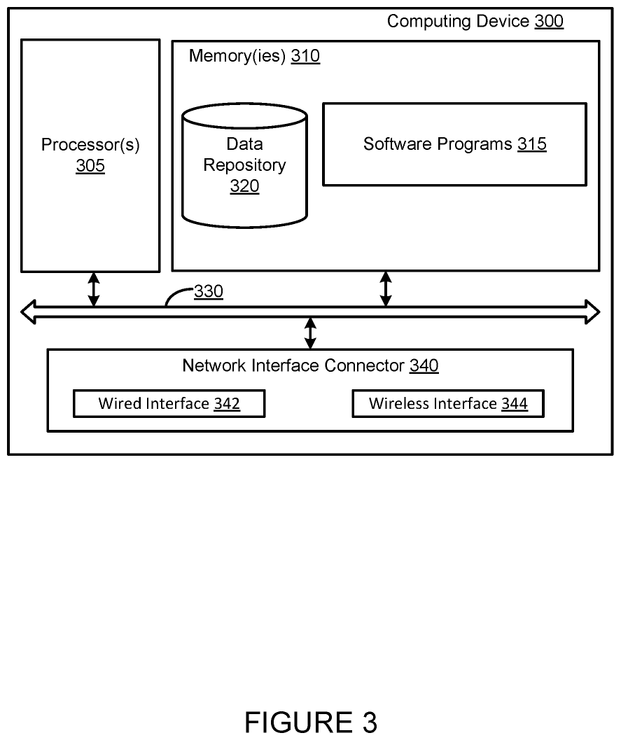

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may include cloud-based processors.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disc, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for auto-thresholding using pairwise feature cross-correlation for hyperparameter value selection, comprising:
receiving, by a hyperparameter value optimization computer program executed by an electronic device, data to be used by a clustering algorithm;
receiving, by the hyperparameter value optimization computer program, a selection of a hyperparameter value to tune;
for each possible hyperparameter value, executing, by the hyperparameter value optimization computer program, the clustering algorithm resulting in a set of clusters for each hyperparameter value;
extracting, by the hyperparameter value optimization computer program, a series of cluster features from the set of clusters;
performing, by the hyperparameter value optimization computer program, pairwise cross-correlation on the series of cluster features resulting in potential candidates for an optimal hyperparameter value;
aggregating, by the hyperparameter value optimization computer program, maximum or minimum values for the hyperparameter value at their respective indices;
selecting, by the hyperparameter value optimization computer program, an optimum value for the hyperparameter value; and
outputting, by the hyperparameter value optimization computer program, the optimum value for the hyperparameter value to the clustering algorithm.

2. The method of claim 1, wherein the clustering algorithm is selected from the group consisting of K-means clustering and DBScan.

3. The method of claim 1, wherein the cluster features include a first order difference in size, a normalized entropy, a Davies-Bouldin score, a Calinski-Harabasz index, and a silhouette coefficient.

4. A non-transitory computer readable storage medium, including instructions stored thereon, which when read and executed by one or more computer processors, cause the one or more computer processors to perform steps comprising:
receiving a selection of a hyperparameter value to tune for a clustering algorithm;
for each possible hyperparameter value, executing the clustering algorithm resulting in a set of clusters for each hyperparameter value;
extracting a series of cluster features from the set of clusters;
performing pairwise cross-correlation on the series of cluster features resulting in potential candidates for an optimal hyperparameter value;
aggregating maximum or minimum values for the hyperparameter value at their respective indices;
selecting an optimum value for the hyperparameter value; and
outputting the optimum value for the hyperparameter value to the clustering algorithm.

5. The non-transitory computer readable storage medium of claim 4, wherein the clustering algorithm is selected from the group consisting of K-means clustering and DBScan.

6. The non-transitory computer readable storage medium of claim 4, wherein the cluster features include a first order difference in size, a normalized entropy, a Davies-Bouldin score, a Calinski-Harabasz index, and a silhouette coefficient.

7. An electronic device, comprising:
a computer processor; and
a memory storing a hyperparameter value optimization computer program;
wherein, when executed by the computer processor, the hyperparameter value optimization computer program:
receives a selection of a hyperparameter value to tune for a clustering algorithm;
for each possible hyperparameter value, executes the clustering algorithm resulting in a set of clusters for each hyperparameter value;
extracting a series of cluster features from the set of clusters;
performs pairwise cross-correlation on the series of cluster features resulting in potential candidates for an optimal hyperparameter value;
aggregates maximum or minimum values for the hyperparameter value at their respective indices;
selects an optimum value for the hyperparameter value; and
outputs the optimum value for the hyperparameter value to the clustering algorithm.

8. The electronic device of claim 7, wherein the clustering algorithm is selected from the group consisting of K-means clustering and DBScan.

9. The electronic device of claim 7, wherein the cluster features include a first order difference in size, a normalized entropy, a Davies-Bouldin score, a Calinski-Harabasz index, and a silhouette coefficient.
